(19) United States
(12) Patent Application Publication
(10) Pub. No.: US 2006/0129977 A1
(43) Pub. Date: Jun. 15, 2006

(54) Data editor

(76) Inventors: Andrew Paul Segar, Auckland (NZ); Geoffrey David Pryor, Auckland (NZ)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/256,021

(22) Filed: Oct. 20, 2005

(30) Foreign Application Priority Data
Dec. 1, 2004 (NZ) 536931

(51) Int. Cl. G06F 9/44

(52) U.S. Cl. 717/110; 717/113

(57) ABSTRACT

A computer program consisting of or including a data editor and/or a relationship editor, the editor constructed so that when it is running it presents a series of data nodes on a display screen wherein such nodes can be selected to enable editing of data corresponding to each node without a user having to open a window, frame or panel, to access such data, or a user having to go to a separate window, frame, or panel and open a file there to access such data.

### FIELD OF THE INVENTION

This invention relates to a data editor. A preferred form of the invention relates to a data editor for editing data contained in a computer database. In at least some embodiments of the invention the editor can be used to edit data in other applications.

### BACKGROUND

In the context of editing electronically stored data, for example in a computer database, it is known to employ a data editor software application. This may be arranged over a database and enable one to manipulate the data contained therein. Known data editors display information on-screen in the form of a “navigation tree” incorporating a series of nodes, each of which designates a different category of data. An example of this can be seen with the Windows Explorer™ software application commonly used in Microsoft Windows™ operating systems.

A disadvantage with many known navigation trees is that they require an undesirable number of steps before one can actually edit data. For example, with the Windows Explorer™ application one must first click on the node of interest to gain access to the associated data. After clicking on the node a secondary panel or the like presents files which can be accessed to view or edit data. When editing is complete the changes are saved and the file is closed. All of this can be undesirably time consuming in the context of large scale data entry. It is accordingly an object of one embodiment of the present invention to go at least some way towards addressing this disadvantage, or to offer the public a useful choice.

The term “comprising”, “comprises”, or derivatives thereof, if and when used herein, should be interpreted non-exclusively—i.e., to convey “consisting of or including”.

### SUMMARY OF THE INVENTION

According to one aspect of the invention there is provided a computer program consisting of or including a data editor and/or a relationship editor, in either case the editor constructed so that when it is running it presents a series of data nodes on a display screen wherein such nodes can be selected to enable editing of data corresponding to each node (e.g., within a tree itself) without a user having to open a window, frame, or panel, to access such data, or a user having to go to a separate window, frame, or panel and open a file there to access such data.

Optionally selecting one of the nodes causes the node to expand to present data for editing (e.g., the extended node presents data within an editable data field).

Optionally the editor, when running, displays at least one node which can be selected to present a branch of sub-nodes, each sub-node being selectable to enable data corresponding to such sub-node to be edited (e.g., within a tree itself) without a user having to open a window, frame, or panel to access such data, or a user having to go to a separate window, frame, or panel and open a file there to access such data.

Optionally at least one of the nodes, or if applicable sub-nodes, presents summary information on sub-nodes (if present) beneath it.

Optionally at least some of the nodes, or if applicable sub-nodes, incorporate a link or links. The link or links may be in the form of a hyperlink navigable from the node concerned.

Optionally the programme is running within a computer or is in a stored form—for example recorded on a storage disc or drive.

### DESCRIPTION OF THE DRAWING

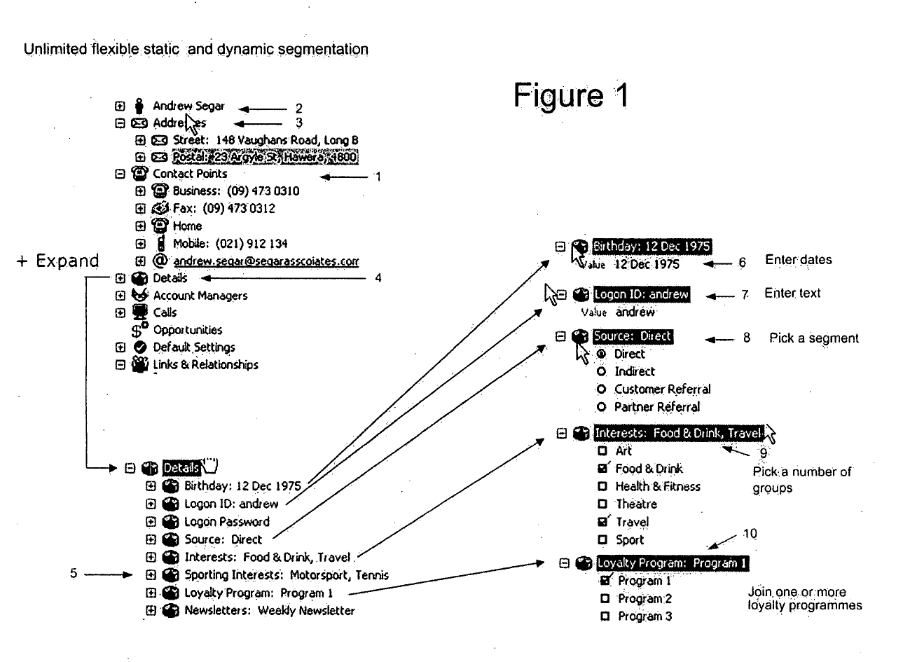

Some preferred embodiments of the invention will now be described by way of example and with reference to FIG. 1, which demonstrates the functionality of a data editor in accordance with the invention.

### DETAILED DESCRIPTION

According to the invention there is a software application which can be used to display and edit data in various environments, for example in the context of a computer database. When used with or as part of a database the editor may display a series of nodes in a navigational drill down tree format. As shown, the base nodes 1 for the navigation tree are labeled “Andrew Segar” through to “Links & Relationships”. Each of these base nodes relates to a specific category of data, for example the first node 2 deals with the name of an individual, the second node 3 deals with the individual's addresses, etc. The data in each node is displayed alongside the node's icon within an editable field (which forms part of the node concerned). In some embodiments of the invention the data for each node may appear by default, and in other embodiments it may only appear when the node is specifically selected (e.g., with a computer mouse). Optionally the editor may provide both types of node.

A useful feature of the invention is that the editor allows a user access to data corresponding to the nodes within the tree without him or her having to select the node and then wait for a separate window, frame, or panel to open to allow editing of data. With the embodiment of the invention displayed in FIG. 1 the editable data in each case either presents automatically, or presents in an expanded form of the node when the node is selected. In the context of large scale data entry this presents significant benefits as computer operators do not have to go through an undesirable number of additional steps to edit data within a window, frame, or panel opened after selection of a node. Those skilled in the art will appreciate that there is a significant difference between working with a node/expanded node, etc., and opening a window, frame, or panel.

In at least some cases selection of the base nodes 1 presents a corresponding branch of nodes. For example, if an operator selects the base “details” node 4 a primary branch of nodes 5 is displayed on screen. Selecting nodes from within this primary branch 5 results in corresponding displays of secondary branches 6, 7, 8, 9, and 10 each in turn. In some embodiments of the invention the editor may provide for subsequent branches from at least some of the secondary branches.

Those skilled in the art will appreciate that a data editor arranged in accordance with the invention may allow for “in line” editing of data as opposed to editing data in a window or the like opened after selecting a node. In at least some cases editing data in a window which has opened may require a secondary editor, whereas in the preferred form of the invention this is not necessary. An editor formed according to the invention may allow for an operator to tab between the data fields corresponding to each node, thus enabling speedy editing of data—e.g., using a key board and a computer mouse.

In a preferred embodiment of the invention the data editor is constructed such that:

within each node there is a set of sub nodes, incorporating editable fields, links, and/or grouping nodes, and/or

when editing is complete the new field value for the data is shown adjacent the corresponding node, and any summary data configured may be presented on higher level nodes, and/or

links, if present, are presented as hyperlinks navigable from the corresponding node.

As a person with normal skills in the relevant field of technology will be able to readily write the code necessary to create and implement the editor it is considered unnecessary to provide further details of the software or its architecture herein.

While the invention has been specifically described in the context of a computer database editor it should be appreciated that it can be used in other computer applications, for example a file and document storage/retrieval system.

While some preferred forms of the invention have been described by way of example it should be appreciated that modifications and improvements can occur without departing from the scope of the appended claims.

What is claimed is:

1. A computer program consisting of or including a data editor and/or a relationship editor, the editor constructed so that when it is running it presents a series of data nodes on a display screen wherein such nodes can be selected to enable editing of data corresponding to each node without a user having to open a window, frame or panel, to access such data, or a user having to go to a separate window, frame, or panel and open a file there to access such data.

2. A program according to claim 1, wherein selecting one of the nodes causes the node to expand to present data for editing.

3. A program according to claim 1, wherein the editor, when running, displays at least one node which can be selected to present a branch of sub-nodes, each sub-node being selectable to enable data corresponding to such sub-node to be edited without a user having to open a window, frame, or panel to access such data, or a user having to go to a separate window, frame, or panel and open a file there to access such data.

4. A program according to claim 1, wherein at least one of the nodes incorporates a link.

5. A program according to claim 1, wherein the nodes are in a tree structure.

6. A computer running a program according to claim 1.

7. A program according to claim 1, substantially as herein described in the detailed description section.

8. A computer program consisting of or including a data editor, the editor constructed so that it presents a series of data nodes on a display screen wherein such nodes are selectable to enable editing of data corresponding to each node without a user having to open a window, frame or panel, to access such data, or a user having to go to a separate window, frame, or panel and open a file there to access such data.

9. A program according to claim 8, constructed such that selecting one of the nodes causes the node to expand to present data for editing.

10. A program according to claim 8, wherein the editor, when running, displays at least one node which is selectable to present a branch of sub-nodes, each sub-node being selectable to enable data corresponding to such sub-node to be edited without a user having to open a window, frame, or panel to access such data, or a user having to go to a separate window, frame, or panel and open a file there to access such data.

11. A program according to claim 8, wherein at least some of the nodes incorporate a link.

12. A program according to claim 8, wherein the nodes are in a tree structure.

13. A program according to claim 8, substantially as herein described in the detailed description section.

14. A computer running a program according to claim 8.

15. A computer program consisting of or including a data editor constructed so that it presents a series of data nodes on a display screen wherein such nodes are selectable to enable editing of data corresponding to each node without a user having to open a window, frame or panel, to access such data, or a user having to go to a separate window, frame, or panel and open a file there to access such data;
the program being such that selecting one of the nodes causes that node to expand and present data for editing;
the program also being such that at least one node is selectable to present a branch of sub-nodes, each sub-node being selectable to enable data corresponding to such sub-node to be edited without a user having to open a window, frame or panel, to access such data, or a user having to go to a separate window, frame, or panel and open a file there to access such data.

16. A computer running a computer program according to claim 15.
